(19) United States
(12) Patent Application Publication
(10) Pub. No.: US 2014/0330855 A1
(43) Pub. Date: Nov. 6, 2014

(54) Modifying and Searching Metadata Associated with Electronic Medical Images

(71) Applicant: Lexmark International Technology SA, Geneva (CH)

(72) Inventors: Razvan Atanasiu, Minnetrista, MN (US); David Pierre Gendron, Coon Rapids, MN (US); Charlie Arnold Stark, Ham Lake, MN (US)

(73) Assignee: Lexmark International Technology SA, Geneva (CH)

(21) Appl. No.: 13/902,033

(22) Filed: May 24, 2013

Related U.S. Application Data
(60) Provisional application No. 61/819,027, filed on May 3, 2013.

(51) Int. Cl. G06F 17/30

(52) U.S. Cl. CPC G06F 17/30389
USPC 707/759; 707/769

(57) ABSTRACT

A method of searching electronic medical images according to one example embodiment includes receiving a search request for one or more electronic medical images. The received search request is modified to conform to a metadata system of an electronic database to be searched. The electronic database is searched for electronic medical images according to the modified search request. If a search result is obtained upon searching the electronic database, metadata of the search result is modified to conform to a metadata system of an entity requesting the search.

### CROSS REFERENCES TO RELATED APPLICATIONS

This application claims priority to U.S. Provisional Patent Application Ser. No. 61/819,027, filed May 3, 2013, entitled “Modifying and Searching Metadata Associated with Electronic Medical Images,” the content of which is hereby incorporated by reference in its entirety.

### BACKGROUND

1. Field of the Disclosure

The present disclosure relates generally to health enterprises and more particularly to searching metadata associated with electronic medical images.

2. Description of the Related Art

A computer network includes a variety of computing devices that communicate and share resources and data. A medical imaging environment, for example, may include a number of networked devices including a medical imaging modality that generates medical images of a patient, a diagnostic view station for displaying the images, an output device for printing the images on film or other media and an archive system for storing the images. These devices are often collectively referred to as a picture archiving and communication system (PACS) and may communicate using a number of protocols. The American College of Radiology and National Electrical Manufacturers Association, for example, developed one such protocol referred to as Digital Imaging and Communications in Medicine (DICOM). In general, DICOM defines vendor-independent data formats and data transfer services for electronic medical images.

A PACS permits digital management and sharing of DICOM medical images. The electronic medical images are classified by their associated metadata, which facilitates retrieval of an archived medical image. The metadata fields associated with DICOM medical images may be standardized across multiple PACSs. However, the nomenclature systems used to define the metadata values that populate these fields often differ across multiple PACSs. For example, different PACSs may use different patient identification numbers to identify the same patient. Accordingly, a system to modify and search electronic medical image metadata across multiple PACSs is desired.

### SUMMARY

A method of searching electronic medical images according to one example embodiment includes receiving a search request for one or more electronic medical images. The received search request is modified to conform to a metadata system of an electronic database to be searched. The electronic database is searched for electronic medical images according to the modified search request. If a search result is obtained upon searching the electronic database, metadata of the search result is modified to conform to a metadata system of an entity requesting the search.

A method of transferring an electronic medical image according to another example embodiment includes displaying an interface to a user of a first picture archiving and communication system for entry of a request to search electronic medical images stored in an electronic database of a second picture archiving and communication system. A received search request is communicated over the internet to a vendor neutral archive for execution of the search request.

A computer system according to one example embodiment includes a vendor neutral archive configured to receive a search request for one or more electronic medical images, modify the received search request to conform to a metadata system of a first picture archiving and communication system to be searched, search an electronic database of the first picture archiving and communication system for electronic medical images according to the modified search request, and if a search result is obtained upon searching the electronic database, to modify metadata of the search result to conform to a metadata system of a second picture archiving and communication system requesting the search.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a block diagram illustrating a system for communication and storage of electronic medical images according to one example embodiment.

FIG. 2 is a block diagram illustrating a computing device in communication with a web service and a vendor neutral archive for sharing electronic medical images between PACSs according to one example embodiment.

FIG. 3 is a flowchart illustrating a method for dynamically modifying the metadata values of an electronic medical image according to one example embodiment.

FIG. 4 is a block diagram illustrating a computing device in communication with a web service and a vendor neutral archive tier searching electronic medical images across to PACSs according to one example embodiment.

FIG. 5 is a flowchart illustrating a method for searching electronic medical images based on their associated metadata according to one example embodiment.

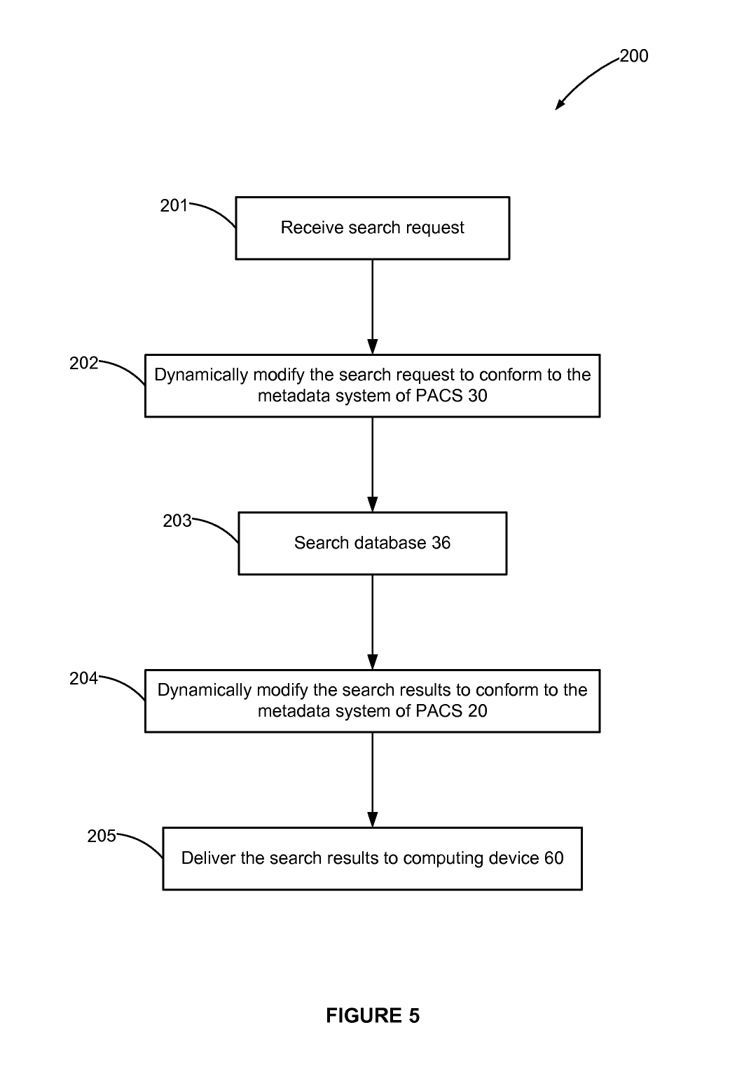

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

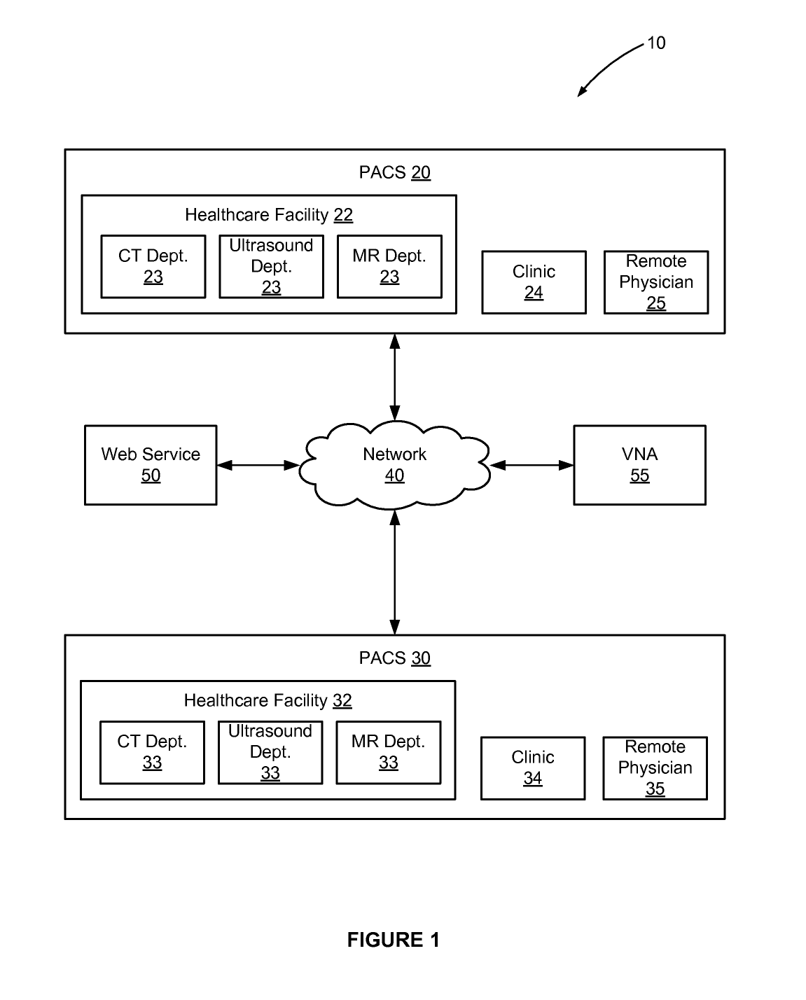

FIG. 1 is a block diagram illustrating a system 10 for communication and storage of electronic medical images according to one example embodiment. System 10 includes PACSs 20, 30. While two PACSs are shown in the example embodiment illustrated, system 10 may include many PACSs. Each PACS 20, 30 includes one or more institutions or entities such as, for example, one or more healthcare facilities 22, 32 each having any number of departments 23, 33. Each department 23, 33 may include a number of medical imaging devices. Departments 23, 33 may include, for example, medical modalities of different types, such as magnetic resonance (MR), computed tomography (CT), digital radiography (DR), ultrasound (US), positron emission tomography (PET), endoscopy (ES), mammograms (MG), computed radiography (CR), etc. Each medical modality may have different imaging characteristics and features and may generate substantially different patient data and associated medical images. Healthcare facilities 22, 32 and departments 23, 33 may also include other computing devices, such as view stations for displaying and annotating medical images and data, an output device for printing medical images and data, a local archive for storing medical images and data and a personal computer (PC) workstation for managing medical images and data. Each PACS 20, 30 may also include one or more remote clinics 24, 34, which may also include computing devices such as medical imaging devices, view stations, output devices, memory devices or PC workstations. Each PACS 20, 30 may also include one or more remote physicians 25, 35 wishing to remotely view or submit medical images and data via a computing device, such as a desktop computer, a laptop computer, a tablet computer or a smart phone.

The various computing devices of PACSs 20 and 30 communicate via a network 40 with a web service 50 and a vendor neutral archive (VNA) 55 that facilitate the transfer and sharing of electronic medical images across system 10 via network 40. Network 40 may be a global network such as the Internet. The computing devices of system 10 may communicate DICOM images having a file format conforming to the DICOM protocol as well as non-DICOM images having a file format that does not conform to the DICOM protocol. In this manner, web service 50 and VNA 55 allow medical professionals to perform collaborative studies on images and data, even when the professionals are in different facilities or different PACSs, even across the country.

The computing devices of system 10 each include one or more processors communicatively coupled to a computer readable storage medium having computer executable program instructions which, when executed by the processor(s), cause the processor(s) to perform the steps described herein. The storage medium may include read-only memory (ROM), random access memory (RAM), non-volatile RAM (NVRAM), optical media, magnetic media, semiconductor memory devices, flash memory devices, mass data storage devices (e.g., a hard drive, CD-ROM and/or DVD units) and/or other memory as is known in the art. The processor(s) execute the program instructions to perform the steps described herein. The processor(s) may include one or more general or special purpose microprocessors, or any one or more processors of any kind of digital computer. Alternatives include those wherein all or a portion of the processor(s) is implemented by an application-specific integrated circuit (ASIC) or another dedicated hardware component as is known in the art.

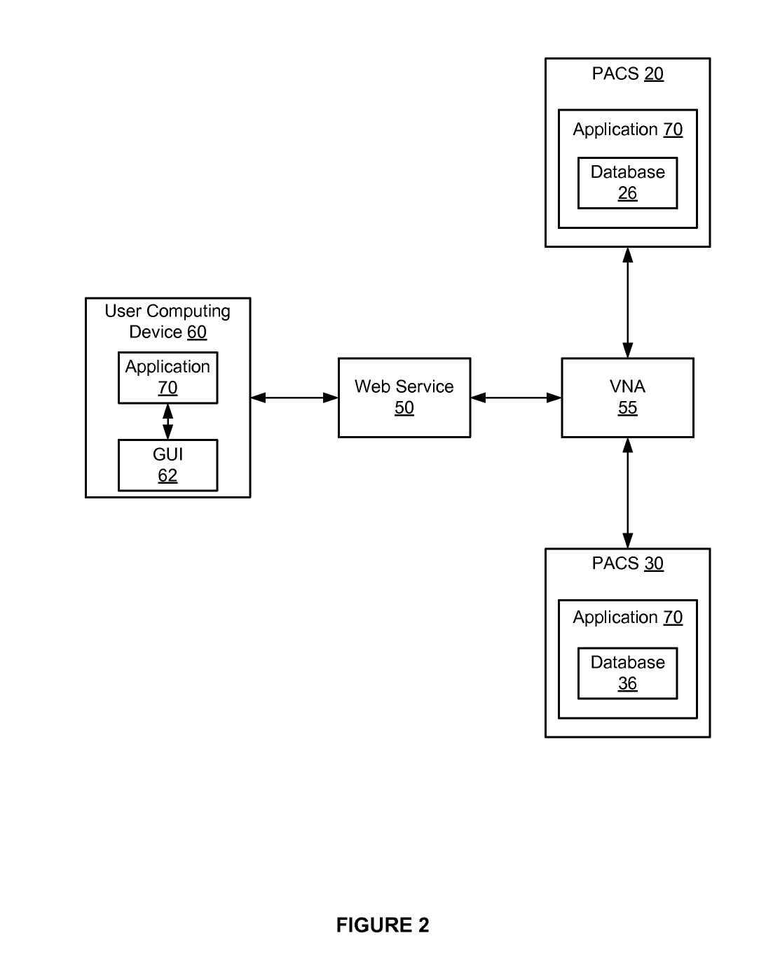

FIG. 2 is a block diagram illustrating a computing device 60 in communication with web service 50, VNA 55 and PACSs 20, 30 for sharing electronic medical images between PACSs 20, 30 according to one example embodiment. Computing device 60 includes a graphical user interface (GUI) 62 that facilitates the entry of user inputs to computing device 60. A software application 70 running on computing device 60 and PACSs 20, 30 provides an interface with web service 50 and VNA 55. In one embodiment, computing device 60 communicates with PACSs 20, 30, web service 50 and VNA 55 over network 40. In another embodiment, computing device 60 may be part of PACS 20 or PACS 30 and may communicate with the other computing devices of PACS 20 or PACS 30 over any Local Area Network (LAN), Wide Area Network (WAN) or global network. PACSs 20, 30 each include a database 26, 36 that stores the electronic medical images related to PACS 20, 30 and their associated metadata.

In one embodiment, application 70 allows a user to move an electronic medical image and its associated metadata from the database of one PACS (the source) over network 40 to the database of another PACS (the destination). In one embodiment, web service 50 receives the move request from application 70 running on computing device 60 and VNA 55 executes the move request and dynamically modifies the metadata values associated with the electronic medical image while the image moves from the source to the destination. The metadata modification may be performed on incoming and/or outgoing DICOM medical images as desired. The metadata modifications may account for differences between the systems used by different PACSs to define the metadata values that populate the XDS metadata fields.

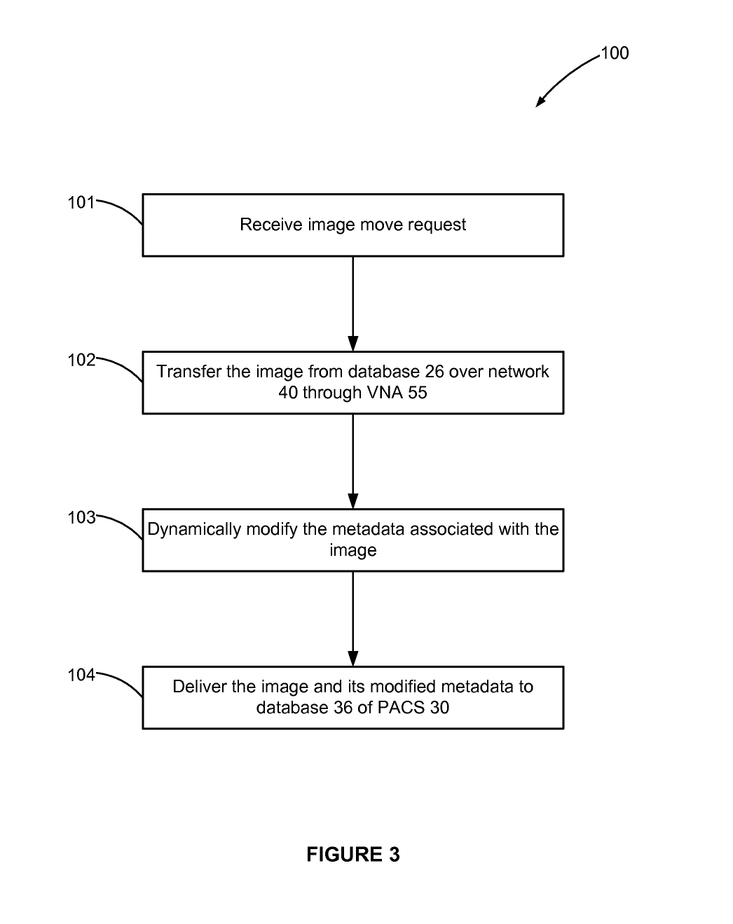

For example, with reference to FIG. 3, a method 100 for dynamically modifying the metadata values of an electronic medical image is shown according to one example embodiment. In this example, PACS 20 is the source of the electronic medical image to be moved and PACS 30 is the destination for the image. At step 101, application 70 running on computing device 60 receives the request to move an electronic medical image stored in database 26 of PACS 20 to database 36 of PACS 30. Under the DICOM protocol, the move request may be a C-Store or a C-Move request. A valid request to move an electronic medical image may include an identification of the image to be moved along with an identification of the source (where the image is currently stored) and an identification of the destination (where is the image is to be sent). For example, the source and the destination may be identified by their respective Application Entity Titles (AE Title). A valid request may also include an identification of the metadata fields to be modified and the metadata modifications to be made. Additional input parameters may be used as desired. For example, a transaction identifier may be provided to allow traceability of the request. The move request and the input parameters may be provided by a user at GUI 62 of computing device 60 or the move request may be automatically generated as desired. The move request may be a “push” type request where a request is made at PACS 20 currently storing the medical image to move the image to PACS 30. Alternatively, the move request may be a “pull” type request where a request is made at PACS 30 to receive the medical image from PACS 20.

At step 102, the electronic medical image is moved from database 26 over network 40 through VNA 55. In one embodiment, application 70 of computing device 60 communicates the move request and the input parameters over network 40 to web service 50. Web service 50 communicates the move request including an identification of the image to be moved as well as its source and destination and an identification of the metadata fields to be modified and the metadata modifications to be made to VNA 55. VNA 55 then executes the move by first obtaining the electronic medical image from database 26 of PACS 20.

As desired, the image may he moved immediately after the request is received and validated. Alternatively, the move may be scheduled for a specified time or after a specified delay. For example, a batch move may be scheduled where a number of electronic medical images are moved at one time from database 26 to database 36. Where a batch move is scheduled, each move request may include a priority value in order to ensure that more important medical images or batches are transferred first. Further, a call back URL may be provided that allows a user to obtain the status of the move request. For either a push type request or a pull type request, VNA 55 may periodically query whether the electronic medical image to be transferred is present in database 26. If the electronic medical image is not present, VNA 55 waits a predetermined amount of time before querying database 26 again. If the electronic medical image is present, VNA 55 transfers the image at step 102. For example, where a patient whose physician is a member of PACS 30 has an appointment to undergo an MRI at a healthcare facility of PACS 20, when the MRI image(s) are expected to be present in database 26 (e.g., based on the time and date of the patient's appointment), VNA 55 may periodically query database 26 for the Mill image(s) in order to promptly transfer them to the patient's physician.

At step 103, VNA 55 dynamically modifies the metadata associated with the electronic medical image as the image is moved, e.g., in order to conform to the metadata system employed by PACS 30. VNA 55 may be configured to process metadata modifications for all inbound and/or outbound electronic medical images entering and/or leaving a particular PACS or VNA 55 may be configured to process metadata modifications for selected images only. The metadata modifications may be read from a command file associated with VNA 55 and executed using information from the command file, from the move request and/or from a database table (e.g., a structured query language (SQL) database table) storing information related to the modifications to be performed. The command file may be, for example, an ASCII text file containing instructions for VNA 55 and may be edited using any basic text editing tool. The instructions may include Boolean logic conditions using a conventional if-then-else construction. VNA 55 may be configured to write to the database table to record modification data from a DICOM message. For example, the command file may be configured to reference the columns or rows of the database table. VNA 55 may also be configured to read data spread across multiple tables and/or to write to multiple tables.

In one embodiment, the DICOM metadata fields to be modified may be identified using either eight numeric characters with no punctuation or separation (e.g., 7e1f0001) or nine ASCII characters if a comma separator is used (e.g., 7e1f,0001). Temporary metadata tags may be used to manipulate and store metadata information and to set conditions for logic flow. Any suitable syntax may be used in the command file associated with VNA 55. For example in one embodiment, the following syntax is used: quotation marks (e.g., “string”) signal an alphanumeric fixed data string, parentheses (e.g., (ColumnName)) signal a column name from the database table, percent symbols (e.g., % ReservedName %) signal dynamic data other than tag data, angled brackets (e.g., <status>) signal a condition regarding the affected tag and number signs (e.g., #num#) signal numeric data.

The metadata modification performed at step 103 may be any suitable or desired adjustment, addition or deletion. For example, an add command may be used to increase the value of a numeric string tag. For example, in one embodiment, the following command increases the value of metadata tag 00082122 by 100: add 0008,2122 “100”. The following command doubles the value of the tag (by effectively adding the value of the tag to itself): add 0008,212.2 0008,2122. Similarly, a sub command may be used to reduce the value of a numeric string tag. For example, in one embodiment, the following command decreases the value of metadata tag 00082122 by 100: sub 0008,2122 “100”.

An append command may be used to add data at the end of a metadata tag. For example, in one embodiment, the following command adds the characters MN following the last characters of metadata tag 00100022: append 0010,0022 “MN”. The following command adds the characters found in the Birthdate column of the database table to the end of metadata tag 00100033: append 00100033 (Birthdate). The following command adds the data from tag 00100044 to the end of tag 00100033: append 00100033 00100044. Similarly, a prepend command may be used to add data to the beginning of a metadata tag. For example, in one embodiment, the following command adds the characters MN to the beginning of metadata tag 00100022: prepend 0010,0022 “MN”.

A leave command may be used to remove all but a specified portion of the metadata value. For example, in one embodiment, the following command removes all characters following the tenth character of the specified tag: leave 00100010 first 10. The following command removes all characters prior to the last seven characters: leave 00100010 last 7. The following command removes all characters preceding a “̂” symbol: leave 0010,0010 after “̂”. Similarly, a trim command may be used to remove a specified portion of a metadata tag. For example, in one embodiment, the following command removes the first ten characters from the specified tag: trim 00100010 first 10.

A create command may be used to insert a new metadata tag to the DICOM medical image. For example, in one embodiment, the following command creates a tag for 00100022 with the characters MN: create 00100022 “MN”. The following command creates a tag for 00100033 with the characters found in the Birthdate column of the database table: create 00100033 (Birthdate). The following command creates a tag for 00100033 with the metadata values from metadata tag 00100044: create 00100033 00100044. The following command creates a tag for 00100033 with the Application Entity name of the document source: create 00100033 % SOURCE_AE_NAME %. The following command creates a tag for 00990099 with the numeric value 256: create 00990099 #256#.

A replace command may be used to remove an existing metadata value and insert a new value. For example, in one embodiment, the following command sets the value of metadata tag 00100033 to the characters found in the Birthdate column of the database table: replace 00100033 (Birthdate). Similarly, a replacetext command may be used to replace a portion of an existing metadata value. For example, in one embodiment, the following command changes Mn to MN in the patient's address (from 101 Main Street, Minneapolis, Minn. to 101 Main Street, Minneapolis, Minn.): replacetext 00100022 “MN” “Mn”.

A clear command may be used to remove the metadata values but keep the metadata field (with a length of zero). For example, in one embodiment, the following command clears the data from the specified tag: clear 00100022. Similarly, a delete command may be used to remove a metadata tag from a DICOM medical image. For example, in one embodiment, the following command deletes the specified tag: delete 0010,0022.

Various commands may be used to adjust the case of alphanumeric string data of a metadata tag. For example, in one embodiment, the following command capitalizes all alphanumeric data from the specified tag: case 00100022 upper. The following command de-capitalizes all alphanumeric data from the specified tag: case 00100022 lower. The following command capitalizes the first character and de-capitalizes all other characters from the specified tag: case 00100022 capfirst.

A process command may be used to parse and execute commands found in the referenced column of the database table. For example, in one embodiment, the following command causes the data in the Commands column of the database table to be parsed and executed: process (Commands).

In one embodiment, if VNA 55 is unable to process a modification command, VNA 55 adds a temporary metadata tag to the electronic medical image identifying the command that failed and the type of error encountered. A log may also be maintained by VNA 55 to track the errors encountered, the metadata modifications successfully completed and any other information related to the metadata modifications desired. In one embodiment, each time an error occurs, VNA 55 logs the following information: the error message, an identifier of the electronic medical image that experienced the error, the name and/or ID of the patient associated with the image and an identifier of the medical imaging modality that generated the image.

Care must be taken to ensure that the metadata modifications comply with the DICOM standard including, for example, length requirements and content restrictions. In one embodiment, VNA 55 enforces length limits on each metadata value it modifies depending on the value representation type of the tag.

At step 104, the electronic medical image and its modified metadata values are delivered by VNA 55 to database 36 of PACS 30. This allows a healthcare professional associated with PACS 30 to access the electronic medical image based on its associated metadata in the metadata format used by PACS 30.

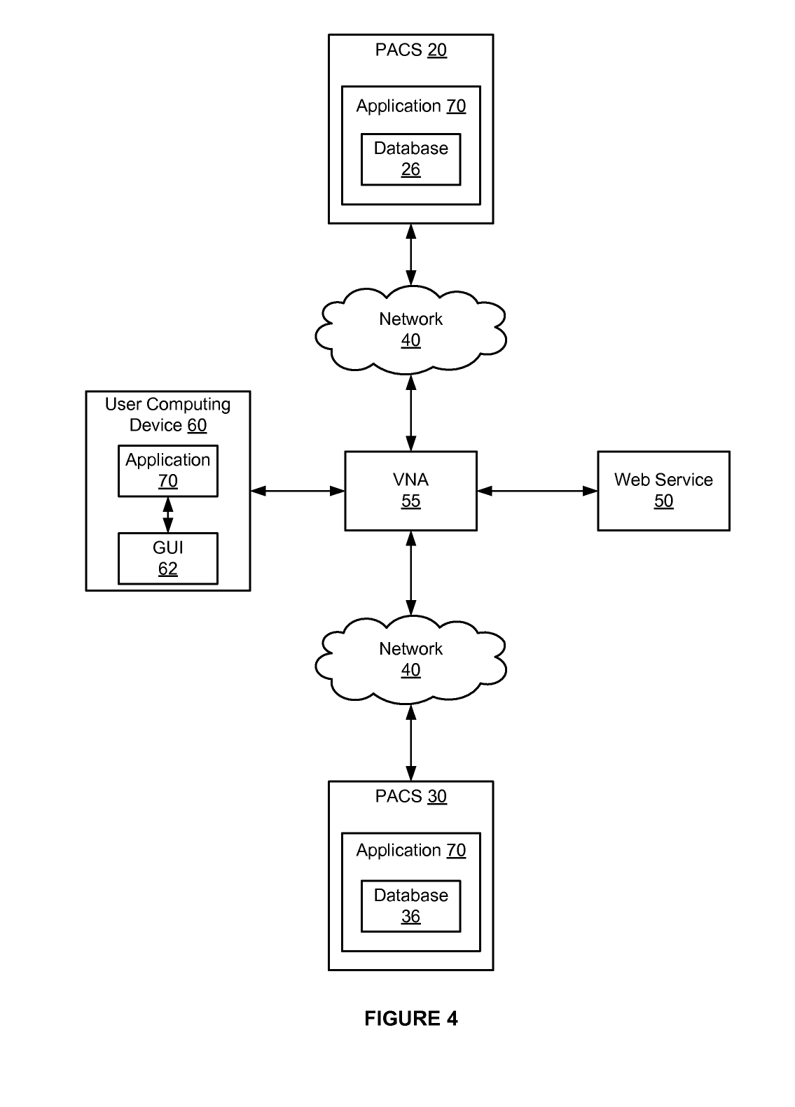

FIG. 4 is a block diagram illustrating a computing device 60 in communication with web service 50, VNA 55 and PACSs 20, 30 for searching electronic medical images across PACSs 20, 30 according to another example embodiment. As discussed above, graphical user interface (GM) 62 facilitates the entry of user inputs to computing device 60. Software application 70 provides an interface with web service 50 and VNA 55. Application 70 allows user to search the electronic medical images stored in a database of one PACS from another PACS. For example, where computing device 60 is included in PACS 20, a user may search documents stored in database 36 of PACS 30 through application 70. VNA 55 receives the search request from computing device 60 and dynamically modifies the search request, e.g., using instructions from web service 50, in order to accommodate the metadata system used by PACS 30. VNA 55 may also dynamically modify the search results obtained in order to accommodate the metadata system used by PACS 20.

With reference to FIG. 4, a method 200 for searching electronic medical images based on their associated metadata is shown according to one example embodiment. At step 101, a search request is received by application 70 running on computing device 60, which in this example embodiment is part of PACS 20. The scope of the search request includes database 36 of PACS 30 (and, as desired, any other PACSs within system 10). The search request may be entered by the user at GUI 62 associated with computing device 60 or it may be automatically generated as desired. Under the DICOM protocol, the search request may be a C-Find or a C-Get request.

The search may be performed according to a number of parameters and filters. For example, a user may search for medical images in one or more specified databases, such as database 36 of PACS 30, or across all databases of system 10. As desired, a user may search for a medical image by an identifier of the image, such as a unique identification number. A user may search for objects related to a single specified patient, multiple patients or all patients. A user may filter the search based on any desired metadata field such as, for example, file name, file status, file type, file author, submitting author, the date or time the image was created, submitted or last updated, the date or time the medical procedure leading to the creation of the image was performed, the healthcare institution or type of healthcare institution under which the image was created, the healthcare professional or type of healthcare professional that created the image, the type of medical procedure that resulted in the image, the confidentiality of the image or any other suitable metadata field.

At step 202, the search request is dynamically modified to conform to the metadata system used by the PACS being searched, which in this example is PACS 30. Application 70 of computing device 60 communicates the search request to VNA 55. In one embodiment, VNA 55 calls web service 50 to obtain the metadata fields to be modified and the metadata modifications to be made. For example, where the search request includes a filter by one or more metadata values, VNA 55 may communicate with web server 50 to determine from web service 50 the corresponding metadata values employed by PACS 30. VNA 55 then changes the metadata values being searched to the corresponding values of PACS 30. The metadata modification performed at step 202 may be any suitable or desired adjustment, addition or deletion including any of the modifications discussed above related to step 103 of method 100. For example, if a search is requested for all medical images associated with a specific patient identification number, the patient identification number associated with the search is changed from the number used to identify the patient by PACS 20 to the identification number used to identify that same patient by PACS 30.

At step 203, VNA 55 and/or application 70 running on PACS 30 executes the requested search in database 36 of PACS 30 according to the modified metadata values. At step 204, the search results are dynamically modified to conform to the metadata system used by the PACS performing the search, which in this example is PACS 20. For example, VNA 55 may communicate with web service 50 to determine from web service 50 the corresponding metadata values employed by PACS 20. VNA 55 then changes the metadata values of the search results to the corresponding values of PACS 20. The metadata modification performed at step 204 may be any suitable or desired adjustment, addition or deletion including any of the modifications discussed above related to step 103 of method 100.

At step 205, the search results are delivered by VNA 55 to application 70 running on computing device 60. The search results conform to the metadata system used by PACS 20 in order to permit a healthcare professional to better interpret the search results. For example, the search results may be filtered further to narrow the search results according to the metadata values used by PACS 20.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

What is claimed is:

1. A method of searching electronic medical images, comprising:
receiving a search request for one or more electronic medical images;
modifying the received search request to conform to a metadata system of an electronic database to be searched;
searching the electronic database for electronic medical images according to the modified search request; and
if a search result is obtained upon searching the electronic database, modifying metadata of the search result to conform to a metadata system of an entity requesting the search.

2. The method of claim 1, wherein modifying the received search request to conform to the metadata system of the electronic database to be searched includes modifying the received search request to conform to a metadata system of a picture archiving and communication system to be searched and searching the electronic database for electronic medical images according to the modified search request includes searching an electronic database of the picture archiving and communication system.

3. The method of claim 1, wherein modifying metadata of the search result to conform to the metadata system of the entity requesting the search includes modifying metadata of the search result to conform to a metadata system of a picture archiving and communication system requesting the search.

4. The method of claim 1, wherein the received search request includes at least one of a DICOM C-Find command and a DICOM C-Get command.

5. The method of claim 1, wherein receiving the search request for one or more electronic medical images includes receiving a search request over the internet for one or more electronic medical images and searching the electronic database for electronic medical images according to the modified search request includes searching the electronic database over the internet.

6. The method of claim 1, wherein modifying the received search request to conform to the metadata system of the electronic database to be searched includes after receiving the search request, receiving modification instructions from a web service and modifying the received search request according to the received modification instructions.

7. The method of claim 1, wherein modifying metadata of the search result to conform to the metadata system of the entity requesting the search includes receiving modification instructions from a web service including an identification of metadata fields to be modified and modifications to be made and modifying the metadata of the search result according to the received modification instructions.

8. The method of claim 1, wherein receiving the search request for one or more electronic medical images includes receiving the search request from a user computing device and further comprising if a search result is obtained upon searching the electronic database, returning the modified search result to the user computing device.

9. A method of transferring an electronic medical image, comprising:
displaying an interface to a user of a first picture archiving and communication system for entry of a request to search electronic medical images stored in an electronic database of a second picture archiving and communication system; and
communicating a received search request over the internet to a vendor neutral archive for execution of the search request.

10. The method of claim 9, further comprising the vendor neutral archive modifying the search request to conform to a metadata system of the second picture archiving and communication system and searching the electronic database of the second picture archiving and communication system for electronic medical images according to the modified search request.

11. The method of claim 10, further comprising if a search result is obtained upon searching the electronic database of the second picture archiving and communication system, the vendor neutral archive modifying metadata of the search result to conform to a metadata system of the first picture archiving and communication system.

12. The method of claim 11, wherein the vendor neutral archive modifying metadata of the search result to conform to the metadata system of the first picture archiving and communication system includes the vendor neutral archive receiving modification instructions from a web service including an identification of metadata fields to be modified and modifications to be made and modifying the metadata of the search result according to the received modification instructions.

13. The method of claim 10, wherein the vendor neutral archive modifying the search request to conform to the metadata system of the second picture archiving and communication system includes the vendor neutral archive receiving modification instructions from a web service and the vendor neutral archive modifying the received search request according to the received modification instructions.

14. The method of claim 9, wherein the received search request includes at least one of a DICOM C-Find command and a DICOM C-Get command.

15. The method of claim 9, further comprising permitting a user to filter search results by patient.

16. The method of claim 9, further comprising permitting a user to filter search results by healthcare provider.

17. A computer system comprising a vendor neutral archive configured to:
receive a search request for one or more electronic medical images;
modify the received search request to conform to a metadata system of a first picture archiving and communication system to be searched;
search an electronic database of the first picture archiving and communication system for electronic medical images according to the modified search request; and
if a search result is obtained upon searching the electronic database, to modify metadata of the search result to conform to a metadata system of a second picture archiving and communication system requesting the search.

18. The computer system of claim 17, wherein the vendor neutral archive is configured to receive the search request over the internet and to search the electronic database over the internet.

19. The computer system of claim 17, wherein the vendor neutral archive is configured to return the search result to a user computing device over the internet.

20. The computer system of claim 17, wherein the vendor neutral archive is configured to communicate with a web service to receive instructions for modifying the received search request and modifying the metadata of the search result.
